(19) United States
(12) Patent Application Publication
(10) Pub. No.: US 2013/0179971 A1
(43) Pub. Date: Jul. 11, 2013

(54) Virtual Machines

(71) Applicant: Keith Harrison, Chepstow (GB)

(72) Inventor: Keith Harrison, Chepstow (GB)

(73) Assignee: HEWLETT-PACKARD DEVELOPMENT COMPANY, L.P., Houston, TX (US)

(21) Appl. No.: 13/822,239

(22) PCT Filed: Sep. 30, 2010
(86) PCT No.: PCT/EP10/64612

§ 371 Date: Mar. 11, 2013

(51) Int. Cl. G06F 21/55

(52) U.S. Cl. CPC G06F 21/55
USPC 726/23

(57) ABSTRACT

A computerized method for detecting a threat by observing multiple behaviors of a computer system in program execution from outside of a host virtual machine, including mapping a portion of physical memory of the system to a forensic virtual machine to determine the presence of a first signature of the threat; and, on the basis of the determination deploying multiple further forensic virtual machines to determine the presence of multiple other signatures of the threat.

### BACKGROUND

Hardware virtualization enables a computing platform to be abstracted from underlying physical hardware. For example, a cloud computing environment may deliver Infrastructure-as-a-service (IaaS) by providing the ability to create virtual machines (VMs) on demand having defined attributes such as size, operating system, number of block devices etc. Typically, the number of VMs can be dynamically changed in response to the demands of a service using the infrastructure to perform certain tasks. These VMs, which may be formed as encapsulated networks, are carved out of the underlying physical hardware.

Hardware virtualization can also be performed on relatively smaller scales, such as using computers and laptops where, for example, multiple different operating systems may be instantiated on the machine in the form of VMs, all using the underlying hardware of the device. In general, irrespective of scale, all hardware virtualization systems control the provision of VMs and their interaction with the underlying physical hardware using a control program called a hypervisor or virtual machine monitor.

In virtualized environments where multiple VMs can be operative at any given time, and wherein each of which may be instantiated to execute a specific program or operating system, there is a risk of attack from malicious machine readable instructions, also termed malware, which can include viruses, worms, Trojan horses, spyware, dishonest adware, crimeware, rootkits, and any other malicious or generally unwanted machine readable instructions. In general, malware will attempt to mask its existence from the software environment that it resides in (such as a VM for example) using various mechanisms which are designed to either obscure or otherwise obfuscate its existence.

### BRIEF DESCRIPTION OF THE DRAWINGS

Various features and advantages of the present disclosure will be apparent from the detailed description which follows, taken in conjunction with the accompanying drawings, which together illustrate, by way of example only, features of the present disclosure, and wherein:

FIG. 1 is a schematic block diagram of an example of a typical cloud computing environment;

FIG. 2 is a block diagram of a virtualized environment according to an example;

FIG. 3 is a schematic block diagram of an example of a process for retrieving a portion of memory allocated to a VM;

FIG. 4 is a schematic block diagram of a virtualized environment according to an example;

FIG. 5 is a schematic block diagram of introspection forensic virtual machines according to an example;

FIG. 6 is a schematic block diagram of introspection forensic virtual machines according to an example;

FIG. 7 is a schematic block diagram of a virtualized system according to an example;

FIG. 8 is a block diagram of a method for detecting a threat according to an example;

FIG. 9 is a block diagram of a method for deploying a forensic virtual machine according to an example; and

FIG. 10 is a functional block diagram of introspection forensic virtual machines according to an example.

### DETAILED DESCRIPTION

Reference will now be made in detail to certain implementations, examples of which are illustrated in the accompanying drawings. In the following description, numerous specific details are set forth in order to provide a thorough understanding of the implementations. Well-known methods, procedures, components, circuits, and networks have not been described in detail so as not to unnecessarily obscure aspects of the implementations.

It will also be understood that, although the terms first, second, etc. can be used herein to describe various elements, these elements should not be limited by these terms. These terms are only used to distinguish one element from another. For example, a first item could be termed a second item, and, similarly, a second item could be termed a first item and so on.

The terminology used in the description herein is for the purpose of describing particular implementations only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or multiple of the associated listed items. It will be further understood that the terms “includes” and/or “including,” when used in this specification, specify the presence of stated features, integers, steps, operations, elements, and/or components, but do not preclude the presence or addition of one or multiple other features, integers, steps, operations, elements, components, and/or groups thereof.

Although the present description predominantly references the use of methods and systems in larger scale environments such as cloud computing environments for example, such methods and systems are equally applicable in smaller scale implementations such as on desktop and laptop computers, and even mobile devices with relatively limited hardware. Accordingly, the examples and implementations set forth herein are not intended to be limited to larger scale systems such as cloud computing environments. The method and system according to the examples presented are uniquely scalable and applicable to multiple virtualized systems ranging from single standalone computers to large scale server farms for a cloud computing infrastructure.

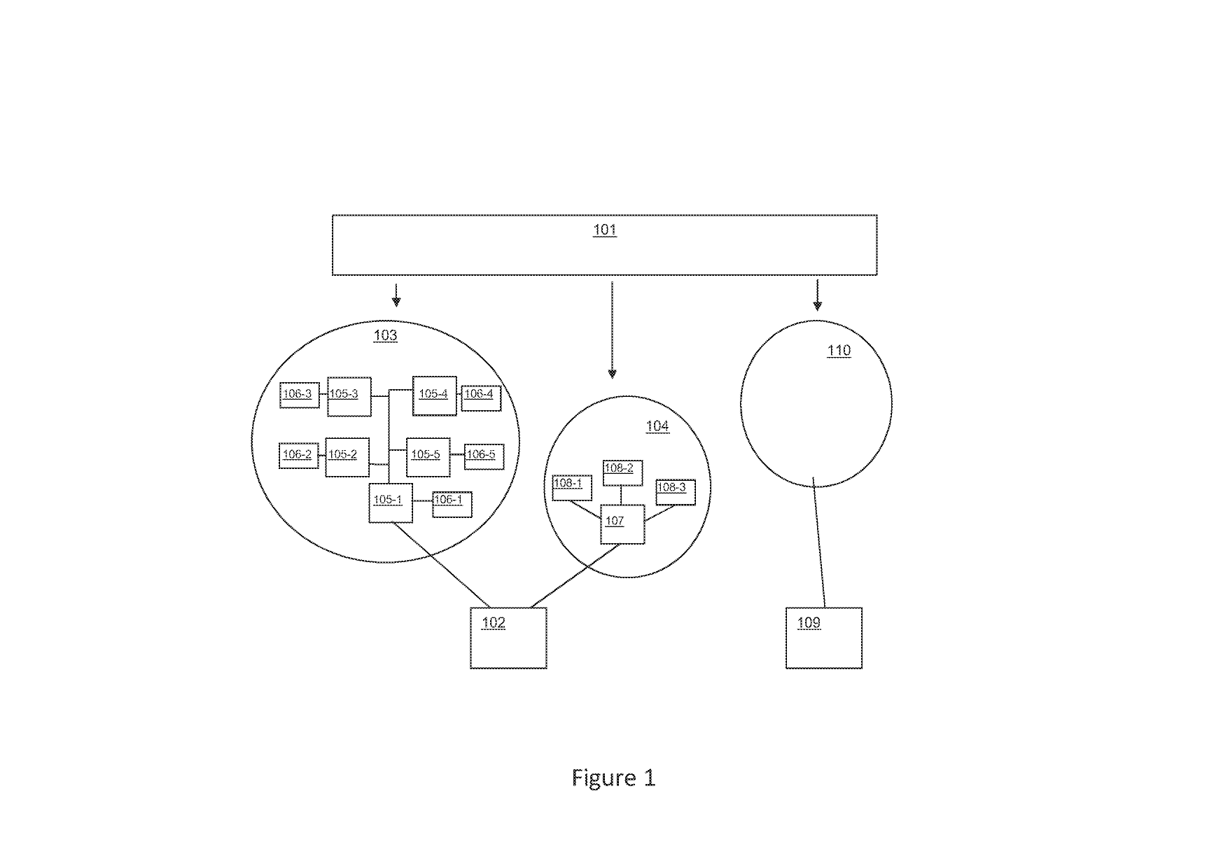

FIG. 1 illustrates an example of a cloud computing environment. In the example shown in FIG. 1, a physical computing hardware infrastructure 101 is shown. The physical computing hardware infrastructure could, for example, include one or multiple data centres or the like comprising a plurality of servers, one or multiple supercomputers or any collection or network of computing resources. The physical hardware may be owned and controlled by one organisation and made available to other organisations, for instance as part of an Infrastructure-as-a-service and/or Platform-as-a-service business, or the hardware could be the hardware of a single organisation operated as a cloud computing environment for its own users.

The physical hardware can be used to provide appropriate virtual machines (VMs) on demand to users. The VMs are associated with volumes, i.e. virtual disks, for operation and data storage. In an implementation, the VMs and volumes can be provided within cells, with each cell being an encapsulated network comprising one or multiple VMs and/or volumes. Within a cell multiple virtual machines may be instantiated and may form a virtual network. Volumes are components of a cell. In the context of cloud computing a volume is a virtual component accessible by a VM that provides persistent storage for persisting the state of a VM or an image or components used to form a VM. In the context of cloud computing a volume is abstracted from any underlying physical storage hardware and thus is separate from and not tied to any particular storage resource or type of resource but provides a single, distinct virtual storage resource with defined attributes such as size.

FIG. 1 shows a first user, 102, running two cells, 103 and 104. The user 102 accesses the cells via a user interface provided by the user's local workstation for example. The user 102 specifies the number and attributes of VMs and associated volumes for the cell. Cell 103 shows an illustrative network of several VMs 105-1 to 105-5 each having an associated volume 106-1 to 106-5. Cell 104 shows an illustrative network comprising a single VM 107 having three associated volumes 108-1 to 108-3. FIG. 1 also illustrates another user 109 running a different cell 110.

A VM is typically created using a machine image of the desired VM. The machine image is effectively a template that provides the VM with a bootable operating system and defined software applications. A machine image is typically cloned onto a volume which is mounted to the VM, i.e. attached to the VM for write and read access. The VM may be created with various volumes attached to it, such as bootable volumes and storage volumes.

In a hardware virtualized environment such as described with reference to FIG. 1, or any other hardware virtualized system, the virtual machine monitor (VMM), or hypervisor, manages the resources of the underlying physical hardware and provides for the abstraction of one or multiple VMs. Each operating system, for example, running in a VM appears to have the host's processor, memory, and other resources, or at least a portion thereof. However, the hypervisor is actually controlling the host processor and resources and allocating what is needed to each operating system in turn and making sure that the guest operating systems cannot disrupt each other.

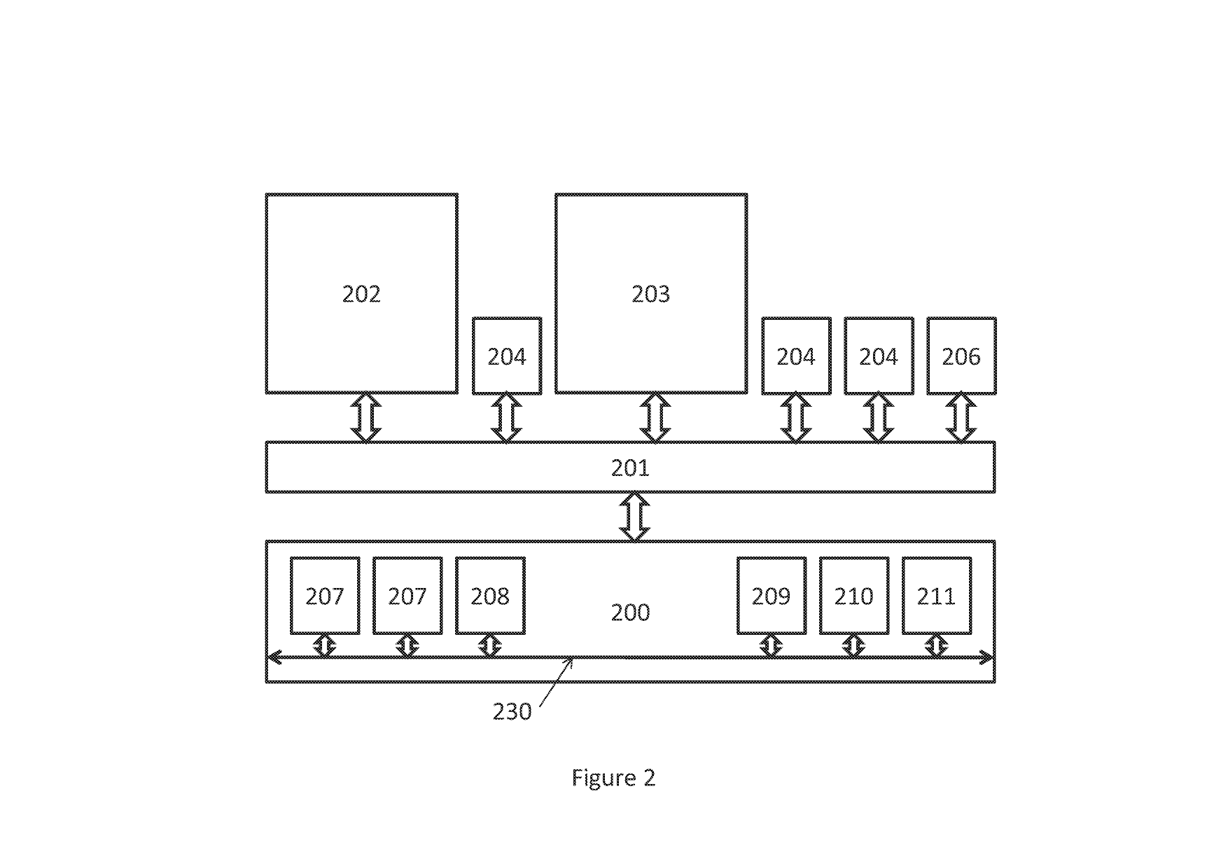

FIG. 2 is a block diagram of a virtualized environment according to an example. A VMM 201 lies above a physical hardware infrastructure 200. Infrastructure 200 typically includes a number of processors 207, which can be multi-core processors, as well as volatile memory 208 such as RAM for example, network interface hardware 209, storage 210 such as hard disk storage for example, graphics processing hardware 211 such as multiple graphical processing processors and so on, all of which can communicate using a bus 230 as is typical. VMs 202, 203 can be instantiated using VMM 201 and are allocated hardware from infrastructure 200. For example, VMMs 202, 203 can be allocated multiple cores from processors 207 depending on the tasks they are destined to perform. A number of smaller VMs 204, 206 (in terms of resources allocated, and/or capability) are instantiated by VMM 201. VMs 204, 206 are virtual appliances which are used to monitor the VMs 202, 203 according to an example as will be described below. An environment with multiple VMs such as that shown in FIG. 2 can be provided as a cell, such as that described with reference to FIG. 1 for example. Alternatively, in a smaller scale environment, the system of FIG. 2 can be provided on a hardware platform including of a laptop or desktop computer, or other suitable hardware.

A VMM 201 can enable the provision of VM introspection, that is to say, the provision of allowing the transparent inspection of a VM from outside of the VM for the purpose of analyzing the software which is running inside it. According to an example, there is provided a method and system for detecting and mitigating the effects of malicious software present in a VM which uses VM introspection. Typically, VM introspection is managed using a library that permits introspection of virtual machines running on the VMM. For example, machine readable instructions can be provided in one VM to enable access to the memory or disk space of other VMs. A VM under inspection is oblivious to the fact that it is being inspected. Calls to inspect a page of memory or portion of a disk are handled by way of the VMM 201. Typically, memory introspection allows an investigating appliance to perform a live analysis of a VM. An investigating appliance can be a DomU (unprivileged domain) VM, or a privileged Dom0 (domain 0) VM, which is typically the first VM instantiated by the VMM on boot. Typically a DomU appliance will work at the behest of a Dom0 VM, but Dom0 is autonomous and can introspect any other unprivileged VM within its scope. It is worth noting that a Dom0 can be split into segments, such as functional segments for example. Accordingly, there can be provided multiple privileged portions of a Dom0. Typically, one such portion is reserved to carry out trusted tasks, such as encryption and decryption for example.

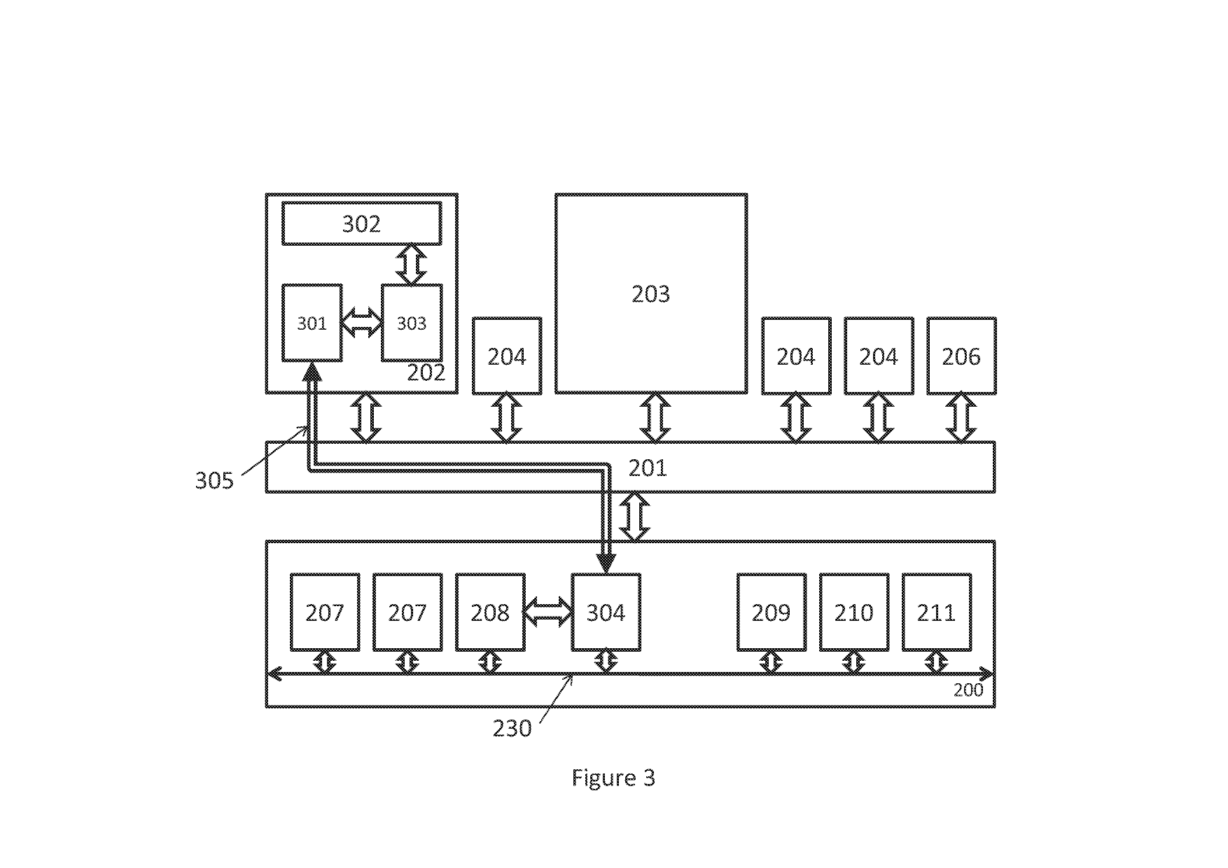

Memory introspection proceeds by mapping a memory page for a VM from physical memory into the memory space of another VM. FIG. 3 is a schematic block diagram of a memory arrangement in a VM according to an example. A VMM 201 manages the resources of multiple CPUs 207, memory 208 and storage 209 for a VM 202. There are typically two main categories of memory relevant to a VM image, VM memory 301 available to the programs and an operating system running inside the VM 202, and physical memory 208, which is the machine memory which is part of the underlying physical hardware 200 for the VM 202. Typically, when running VM 202, VMM 201 creates an addressable memory space for the VM 202 in physical memory 208. This memory space has the same properties as a virtual address space presented to applications by the operating system of VM 202. Accordingly, the VMM 201 can run multiple VMs 202, 203, 204, 206 simultaneously while protecting the memory of each virtual machine from being accessed by others.

Typically, VM 202 will be allocated a non-contiguous block of memory from physical memory 208. However, the VM 202, and more specifically a program or operating system running in the VM 202 may think that it has a range of contiguous memory addresses even though the addresses will typically be scatted around in the physical memory 208. The operating system of the VM 202 has access to multiple page tables which translate the physical memory addresses to virtual addresses for the VM memory 301. Typically, such page tables map the addresses of 4 KB blocks of physical memory for the VM, so that it can be accessed by the VM 202. In a process for the memory introspection of a VM, the VMM 201 can relay the page table information in order to provide a querying system with the physical addresses of memory being used by the VM in question. Since the process is transparent to the VM, it is unaware that the physical memory that has been allocated to it is being read by another source.

A virtual page table 303 holds memory address information for applications 302 of a virtual machine 202 to enable the applications to address virtual memory 301. Virtual memory 301 is mapped to physical memory 208 via physical page table 304. The page table 303 therefore stores data representing a mapping between virtual memory 301 for an application running in VM 202 and physical addresses of memory allocated to the VM 202 from memory 208.

The mapping of virtual memory to physical memory is typically handled by VMM 201, as depicted by arrow 305 indicating that calls to and from virtual and physical memory occur via VMM 201. In the process of memory introspection, VMM 201 typically maps or copies an address space of a VM to the address space of another VM so that the physical memory associated with the address space can be inspected by the other VM. An introspected VM will typically be unprivileged with no direct access to hardware 200. An introspecting VM can be the first domain started by the VMM on boot (Dom0), and can have special privileges, such as being able to cause new VMs to start, and being able to access hardware 200 directly. It will typically be responsible for running all of the device drivers for the hardware 200. Alternatively, an introspecting VM can be an unprivileged VM which has been instantiated by Dom0 and which is typically permitted by Dom0 to perform introspection on other unprivileged VMs.

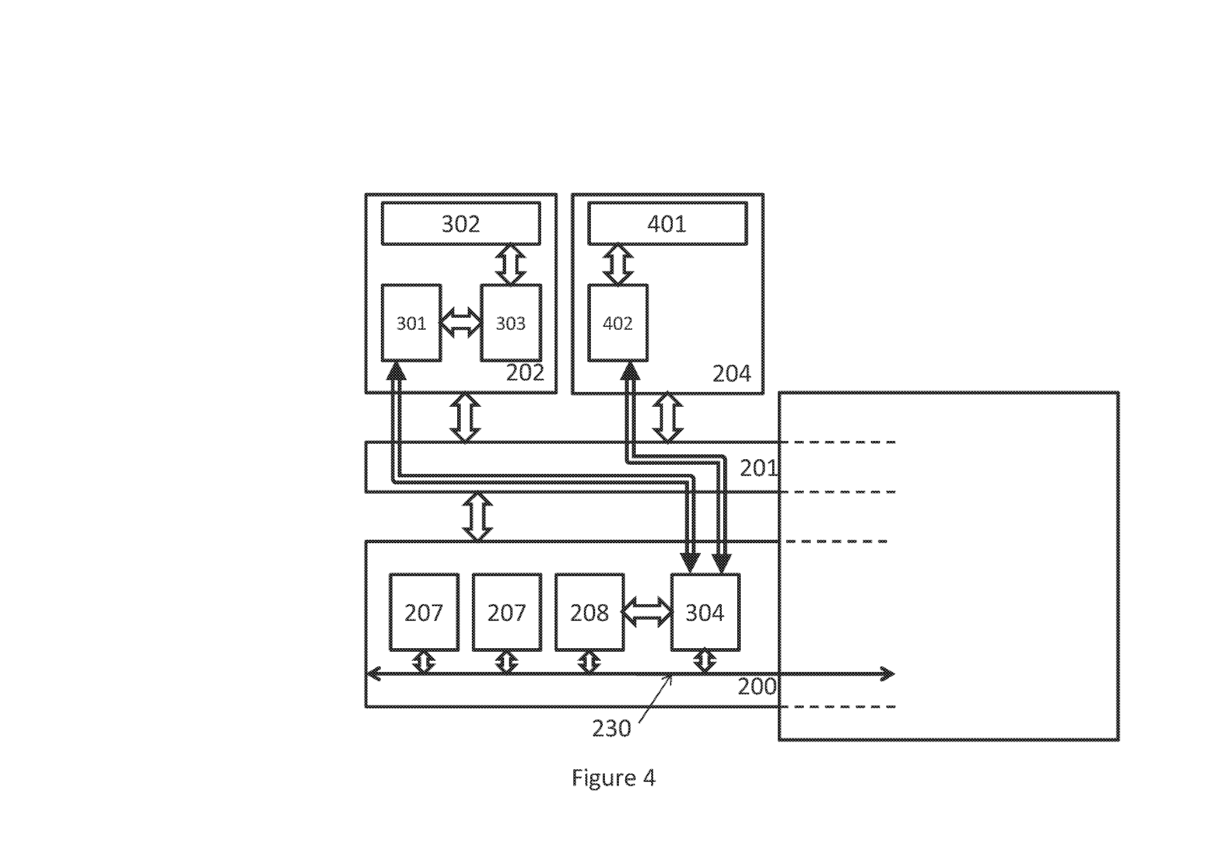

FIG. 4 is a schematic block diagram of a virtualized environment according to an example. VM 202 is a target VM, that is a VM to be introspected or scanned. VM 204 is a virtual appliance for performing a memory introspection of a target VM 202. According to an example, VM 204 is a forensic VM (FVM). FVM 204 can have privileged access to hardware 200 via VMM 201, or may be unprivileged. An application 401 in FVM 204 can request access to a memory space of VM 202. According to an example, requested memory pages assigned to the target VM 202 can be mapped into the address space of the requesting system such as FVM 204, thereby allowing analysis of the memory in question to be performed.

In order to determine an appropriate physical memory frame, page table 304 corresponding to the physical frame in memory 208 is consulted. As described above with reference to FIG. 3, an intermediate action means that the physical frame numbers from the perspective of the target VM 202 are translated into the frame numbers for the underlying hardware 200 before the appropriate page can be available to the requesting system 204. Accordingly, a requesting application 401 in FVM 204 requests to inspect a memory address of a target VM 202, such as an address corresponding to a module in a kernel of the target VM 202 for example. A page table 303 associated with the target VM 202 is used by VMM 201 in order to map memory addresses for the VM to physical memory addresses. Accordingly, VMM 201 determines a VM memory address 301 associated with the requested memory address using a page table 303 for the VM memory. Once the VM memory address is known, it is converted to a physical memory address using page table 304 associated with the mapping of VM memory addresses to physical memory addresses. Once the physical memory address associated with the request is known, it can be mapped into FVM 204 such as by mapping it into a page table 402 for FVM 204 for example, in order to allow the data in the specified address of memory 208 to be read/inspected by FVM 204.

Malware can typically be composed of a number of components which can be relatively easily obtained by someone wishing to implement a piece of malware for a certain purpose. Each component can operate in a way which causes it to have a specific signature or indicator associated with it. That is to say, malware will exhibit certain behaviors and behavior patterns as a result of the way in which it tries to conceal itself, and/or the way in which it may try to alter some function of a system in order to perform some task that it was designed to complete.

Typically, pre-existing components are combined and include a piece of implementing code written by the progenitor of the particular piece of malware. Some components will have a specific behavior pattern in the form of a signature which can be a pattern of data words present in memory at any one time for example. Detection of the pattern can give an indication of the possible existence of a threat. Some components will have a behavior pattern in the form of a signature which can be a series of disjointed system calls for example, and this can be an indication of a piece of software attempting to obfuscate its presence and/or purpose for example. Typically, behaviors which can indicate the presence of suspicious activity can be categorized according to whether the underlying process is static or dynamic. For example, a static process can include a call to some pre-existing machine-readable instructions (e.g. a call to implement a printf function). That is to say, the address linking to the library which contains the data to implement the instruction should not change since the instruction is predefined. Accordingly, a change in the address can indicate that the function call is being changed to implement some other activity before the instruction that it should be pointing to. For example, a different address can point to a piece of malicious code, which performs some unwanted activity and which then points to the correct library afterwards (so as to make sure that the instruction is executed, thereby concealing its presence). Accordingly, a process table can be monitored to make sure that jump addresses remain unchanged (i.e. are static). A change in an address can be a behavior indicative of suspicious activity, and a change can therefore be a signature of a threat.

A dynamic process can include an activity relating to a process table for example, which can be a linked list table including entries relating to each process in a system. More specifically, when a process starts an entry is formed in the table and the process initializes. Once initialization is complete, the entry can be removed or changed to indicate the completion of the initialization. Accordingly, if the dynamic process does not change for more than a predefined period of time (such as a number of seconds, minutes or even hours depending on the process for example) this can be indicative of suspicious behavior. That is to say, a malicious process can pretend it is still in an initialization phase, and will be given CPU time which it can use to perform other unwanted activities. Accordingly, a process table can be monitored to check the entries and determine if any processes are remaining in an unresolved state for more than a predefined period of time. If any are, that can be a behavior indicative of suspicious activity, and such an unresolved state can be a signature of a threat.

Detection of signatures from a number of components can be indicative of the presence of a piece of malware. For example, the presence of certain components can be indicative in of itself. Alternatively, the presence of certain components in combination with one another can be indicative. For example, it may be known that a component C1 in combination with component C4 is used in order to implement a particular function which is generally used in malware. Accordingly, detection of signatures in a target VM relating to both components can give cause to pay more attention to that VM because malware may be present.

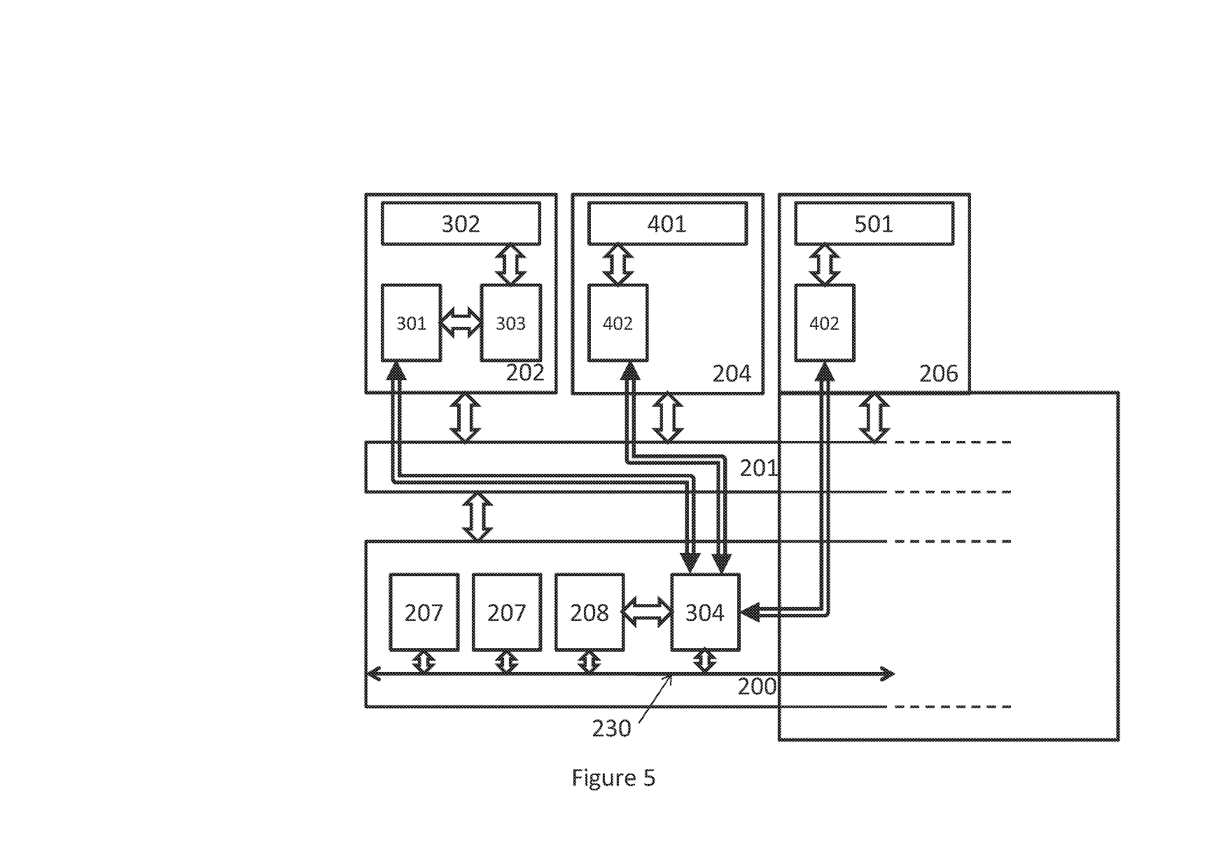

FIG. 5 is a functional block diagram of introspection FVMs 204, 206 according to an example. FVM 204 is a monitoring VM to monitor a target VM 202 or any other target VM instantiated over hardware 200. FVM 204 includes a requesting application 401. According to an example, the requesting application 401 is a specialized agent which is ‘hard wired’ to monitor target VMs for a specific behavior, symptom, signature or indicator associated with one or multiple threats. For example, a specific threat could relate to one particular kind or variety of malware, with a behavior symptom, indicator or signature indicative that the threat is active or otherwise present in the target VM being monitored. It should be noted that, in general, malware will aim to obfuscate its presence using a multitude of tactics. However, such tactics are aimed at concealing its presence from the system in which it resides, which in the present example would be VM 202. Since the FVM 204 remains undetectable to VM 202, any threat/malware within VM 202 cannot easily detect that VM 202 is being monitored by FVM 204.

The VMM 201 effectively provides a substrate that isolates the system from the monitored VM and allows the system to inspect the state of the target VM. The VMM 201 also allows the system to interpose on interactions between the guest OS/guest applications and virtual hardware. According to an example, the requesting application 401 can provide a query to the VMM 201, typically via a library for translating a query from application 401 for VMM 201. Such a query can be a request for the current state of a page of memory of the VM 202 for example. The VMM 201 interprets the query and retrieves the desired data from the VM 202, such as by mapping a page of memory for access by the FVM 204 as described above.

Similarly to FVM 204, FVM 206 includes a requesting application 501 which is a specialized agent to monitor target VMs for a specific behavior, symptom, signature or indicator associated with one or multiple threats. According to the example in FIG. 5, the requesting application 501 of FVM 206 is arranged to introspect the same part of memory 208 as FVM 204, and thus a request from requesting application 501 results in a mapping of that memory in the form of page table 402 for example, which is the same page table as that mapped to FVM 204. Accordingly, multiple FVMs can be instantiated to monitor multiple target VMs for the same threat signature according to an example. Applications 401, 501 may be identical (such that FVMs 204, 206 are effectively clones), or the applications may be different in purpose, such that FVMs 204, 206 are tasked with detecting different signatures which may happen to reside in the same portion of physical memory for example.

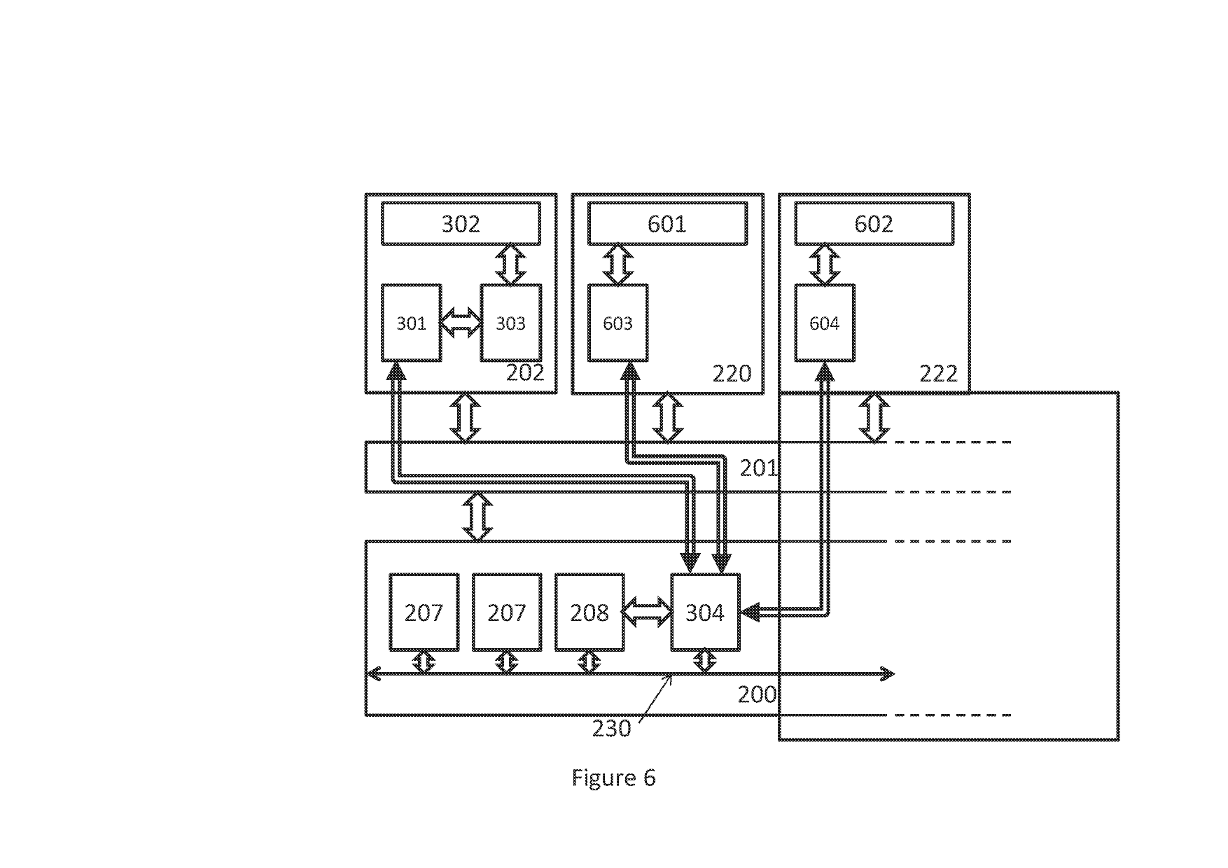

FIG. 6 is a functional block diagram of introspection FVMs 220, 222 according to an example. FVMs 220 and 222 include requesting applications 601, 602, each of which is arranged to determine the presence of different signatures, which signatures can be associated with the same or different threats. Accordingly, the memory locations 603, 604 mapped into each FVM 220, 222 relate to different parts of physical memory 208.

A requesting application can compare a requested part of memory 208 and determine whether or not a threat signature is present. If present, the FVM can determine if a response is desired, and if so what that response may be. For example, in response to the positive detection of a threat signature, the FVM can cause the VMM 201 to suspend or reboot the affected target VM, or relay the information that a signature has been detected so that further FVMs can be deployed as will be described below.

In a virtualized environment comprising a multitude of target VMs, each target VM can be monitored for a specific threat signature using one particular FVM. Alternatively, one FVM can be arranged to monitor multiple VMs for a given threat signature. In either case, and in response to a positive indication that a signature is present or operative in a VM, the FVM can cause multiple other FVMs to engage with an affected VM in order to increase or otherwise maintain the scrutiny on that VM. Such additional FVMs can include those configured to monitor for another threat signature which is different to the initially detected one, but which may still be associated with a particular threat. Typically, an FVM will sequentially scan VMs, as opposed to scanning multiple VMs simultaneously. However, the provision of simultaneously scanning multiple VMs can be used according to an example.

According to an example, multiple FVMs can be used, each of which is designed to determine the presence of multiple different threat signatures. As described, the presence of multiple different threat signatures may be indicative that a particular threat is present and operative in a VM, especially if those multiple signatures are known to be present in combination for certain malware components. In the case where a threat signature can be present across a number of different threats, such as when a particular component can be used in multiple different pieces of malware for example, multiple FVMs arranged to detect that signature can be deployed. For example, if it is known that a component C2 is used in a prolific way in various pieces of malware (as it is the easiest or best way to implement a certain function for example), multiple FVMs capable of determining the presence of a signature corresponding to the presence of C2 can be deployed in a virtualized system. According to an example, each such FVM can determine the presence of the signature in one target VM. Alternatively, multiple FVMs can be used with one target VM in order to determine the presence of a signature, particularly if that signature is transient in nature (such as being a set of words stored in memory which is regularly changed, moved or deleted for example). Accordingly, multiple FVMs searching for a given signature will have a better chance of detecting it by virtue of the fact that they are able to monitor a larger portion of the memory allocated to the VM than one FVM alone.

A signature in the form of specific data present in a page of memory read by an FVM can be relatively small. Accordingly, if that data is present, it can serve as a prompt in order to pay more attention to a VM in which the signature has been found, which can include deploying multiple other FVMs in order to read one or multiple memory pages of the target VM in question. For example, multiple other FVMs can corroborate the presence of the threat by determining the presence of other indicative signatures, and/or by verifying the presence of the initial signature. For example, as described above, if components are usually used in combination, the multiple other FVMs can be deployed to scan the target VM for the presence of other signatures relating to components which are known to generally be present in combination with the detected component.

According to an example, an FVM can periodically read a memory page of a target VM in a system being monitored, and the target VM can be the same VM (scanned at periodic intervals), or a different VM (with a change of VM and scan occurring at periodic intervals). The periodic request from the FVM can be random or planned. For example, a ‘roving’ FVM can read a page of a memory of one or multiple VMs at random or set periodic intervals. The choice of VM to inspect, and the length of a period between inspections can be set randomly according to number generated using a random seed associated with the FVM. Alternatively, the choice of a VM to inspect, and the interval between inspections can be selected according to an inspection scheme which is operative to ensure that multiple VMs are inspected on a periodic basis which reduces the chances that a threat signature is missed by an FVM. According to an example, every VM present in a virtualized environment can have an FVM associated with it. In circumstances where a threat is present and one or multiple signatures of the threat are detected, FVMs can shift their focus from the VM that they are associated with in order to provide additional support in the detection or confirmation of the threat associated with the detected signature.

In order for an FVM which is designed to determine the presence of a specific signature to register the presence of the signature, it can compare a set of data words read from a physical memory location allocated to a VM with those for an existing threat signature. For example, a virtual memory in an FVM can be used to store data representing a set of signatures which can be used for comparison with data read from the memory space of a target VM. The requesting application (such as 601, 602 for example) can be used to perform a comparison using allocated physical resources (that is resources allocated form hardware 200 by VMM 201). For a signature, a match can include where all or a proportion of the data is the same. For example, if 60% or more of the data read by an FVM matches that of a threat signature, the FVM can indicate that a possible match has been found which can cause the deployment of other FVMs. This is useful in situations where a signature can change over time, so that a portion detected at one point is time may be different 1 second later for example.

According to an example, a match can be determined in the FVM as described above, or in the VMM 201. For example, irrespective of the data it reads, an FVM can relay data to the VMM or another ‘master’ or supervisory FVM in order for a comparison to be made against known signatures. A supervisory FVM can include a virtual memory (or other memory such as a portion of a storage medium in hardware 200 for example) to store data representing a task list for FVMs in a system. For example, a task list can include a listing of VMs which should be inspected, along with an order in which the VMs should be inspected. The task list may therefore represent a priority listing of VMs for inspection. According to an example, FVMs may periodically query the list in order to determine a VM to inspect, which VM is then removed from or shifted in position on the list in anticipation of the fact that it will be inspected. If a VM is found to include a signature indicative of the potential presence of a threat, its position and prominence on the task list can be escalated so that other FVMs are made aware that it should be inspected. Alternatively, if a VM is found to include a signature indicative of the potential presence of a threat which is classed as a major threat, supervisor FVM or the VMM may force a VM to be inspected off-cycle—that is, outside of the normal task list inspection rota.

According to an example, if a signature is detected, and multiple other FVMs are deployed to determine the possible presence of other signatures for a given threat, and these are found (or a proportion are detected to provide a level of confidence that the threat is present), a VM can be suspended or shut down. Prior to or after suspension (or shut down as appropriate), a partial or complete mirror of the memory and/or disk status of the VM can be provided for further inspection.

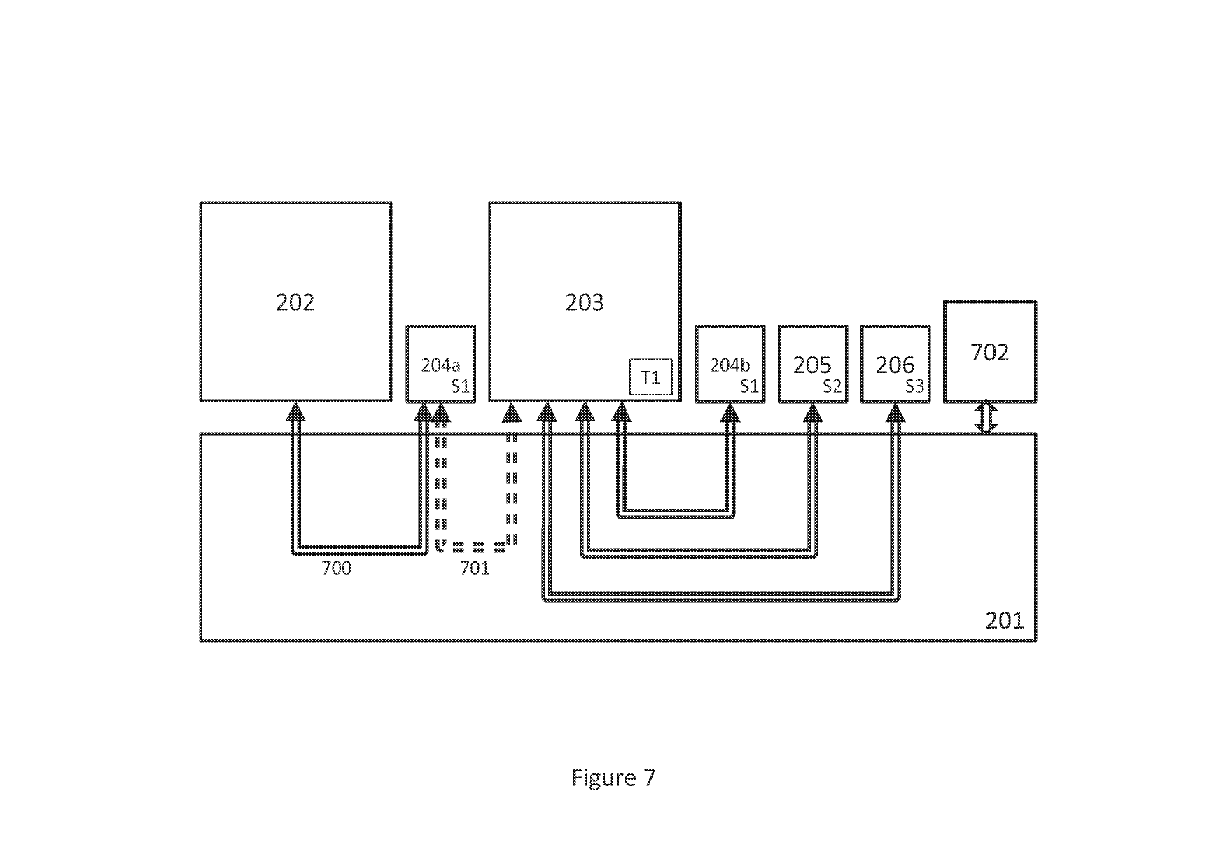

FIG. 7 is a schematic block diagram of a virtualized system according to an example. Note that the underlying physical hardware has been omitted so as not to obscure the diagram. Solid lines between modules in FIG. 7 are indicative of an active link between the modules. For example, the link 700 between VM 202 and FVM 204a indicates that 204a is actively linked to VM 202 in such as way that it is able to read a portion of physical memory allocated by VMM 201 to VM 202, or otherwise access a portion of physical disk space of VM 202. Accordingly, two target VMs 202, 203 are monitored by FVMs 204a, 204b for a specific signature which those FVMs are tasked with detecting. For example, target VM 202 is monitored (continuously or on a periodic basis) by an FVM 204a to detect the presence of a signature S1. Target VM 203 is monitored by an FVM 204b to detect the presence of signature S1 in that VM. Accordingly, FVMs 204a and 204b monitor for the same signature, although it is entirely feasible that they could be looking for looking for evidence of different signatures or behaviors. If signature S1 is detected by FVM 204b in VM 203, it can report the presence of S1, at which point multiple other FVMs can be deployed by VMM 201 or a supervisory FVM 702. The other FVMs can be those which are already instantiated on the system, or can be new FVMs generated by VMM 201 in response to the indication of detection of S1 (such as in response to an indication from FVM 702 for example). According to the example of FIG. 7, FVMs 205 and 206 are deployed to monitor VM 203 for signatures S2 and S3 respectively. Signatures S2 and S3 can be signatures that are known to be likely to be present if signature S1 has been detected, and the combination of S1, S2 and S3 can be indicative of a malware threat T1 to the system.

Thus, according to an example, the presence of signature S1 in VM 203 means that FVMs (205, 206) are deployed to monitor the VM 203. In addition, it is possible that FVM 204a can be redeployed from monitoring VM 202 to monitor VM 203, as indicated by line 701. The redeployment of an FVM can occur if the threat T1 is particular high risk for example, and as such warrants extra resource to determine its presence. Alternatively, FVM 204a can be redeployed to verify the presence of signature S1 irrespective of the level of risk posed by threat T1. According to another example, FVM 204a can be redeployed and transformed to search for an alternative signature. That is, FVM 204a can be redeployed to monitor VM 203 for a signature which is different to any other signature which the VM is currently being monitored for, such as a signature S4 for example. Accordingly, if threat T1 is suspected (as a result of detection of signature S1, and/or the combination of signatures S1, S2 and S3 for example), and this threat is classed as higher risk for VM 203, an FVM (such as 204a) which is currently monitoring another VM in which it has not detected the presence of any signatures, can be redeployed to monitor the threatened VM for a signature which it was not originally tasked to detect. Accordingly, VMM 201 can modify the FVM 204a to detect signature S4 and redeploy.

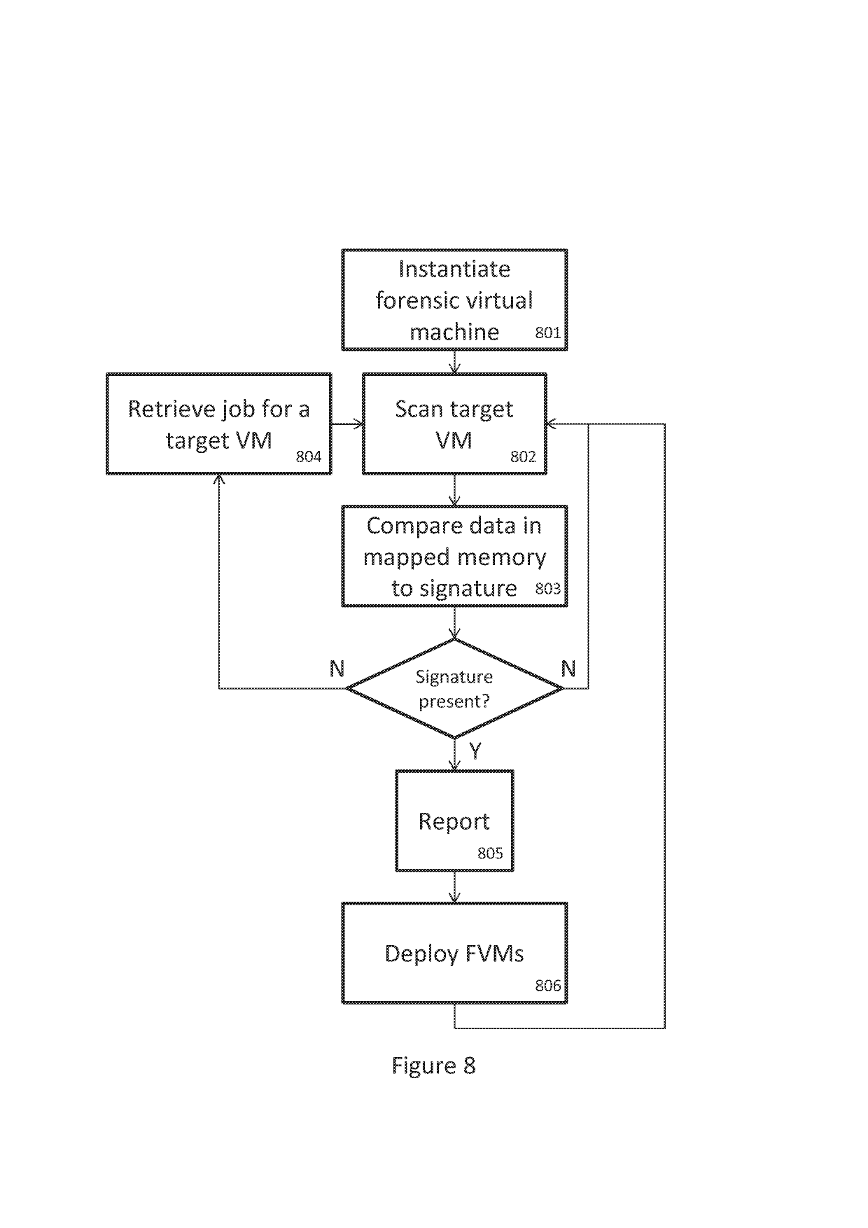

FIG. 8 is a block diagram of a method for detecting a threat according to an example. In block 801 a forensic virtual machine is instantiated, such as using VMM 201 over hardware 200 for example. The FVM of block 801 is tasked to determine the presence of a signature, such as a signature S1 which (amongst others) can be indicative of the presence of a threat T1 in a system. In block 802, a target VM is scanned by the FVM instantiated in 801. For example, a portion of memory or disk space of the VM can be scanned by the FVM. In block 803 data from a mapped portion of the memory allocated to the VM is compared to that of the signature (such as S1) in order to detect if the signature is present. If the signature is not present, the FVM can scan the VM again, or scan another VM such as by retrieving a job from a task list of VMs to be scanned in block 804 for example. If the signature is present, the detection can be reported in block 805, such as to VMM 201 or a supervisory FVM 702. In response to the report, multiple other FVMs can be deployed in block 806 to scan the VM in question. The multiple other FVMs of block 805 can be FVMs to scan for signature S1 or multiple other signatures, which can be other signatures representative of the presence of threat T1.

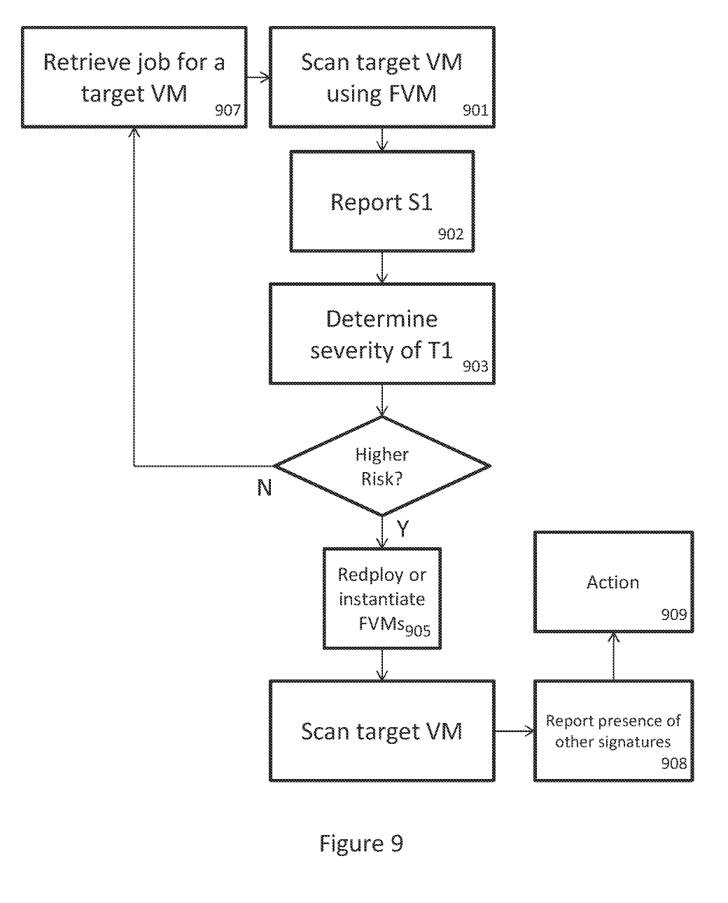

FIG. 9 is a block diagram of a method for deploying a forensic virtual machine according to an example. An FVM for scanning a target VM scans a target VM in block 901. In response to detection of a signature S1 for a threat T1, the FVM can report the presence of S1 to a VMM 201 or FVM 702 in block 902. In response to the report, the level of threat posed by threat T1 is determined in block 903, such as with reference to a listing of possible threats and the severity of leaving them unchecked for example. If the threat T1 is determined as a higher risk threat, in block 905 VMM 201 or FVM 702 can cause other existing FVMs to be deployed or new FVMs to be instantiated, or a combination. A redeployed FVM can be reprogrammed by VMM 201 or FVM 702 to search for a signature which is different to the signature it was originally destined to detect. Newly created FVMs can be created to detect specific signatures associated with the presence of T1 for example. Redeployed or new FVMs can perform introspection in block 906 on the target VM to detect the presence of multiple other signatures for threat T1. If threat T1 is determined as lower risk, the FVM can retrieve a job in block 907 to scan another target VM.

If, following the action in block 906 other signatures indicative of T1 are detected, this can be reported in block 908 to VMM 201 or FVM 702 so that appropriate action can be taken in block 909, such as suspending or killing the affected VM for example.

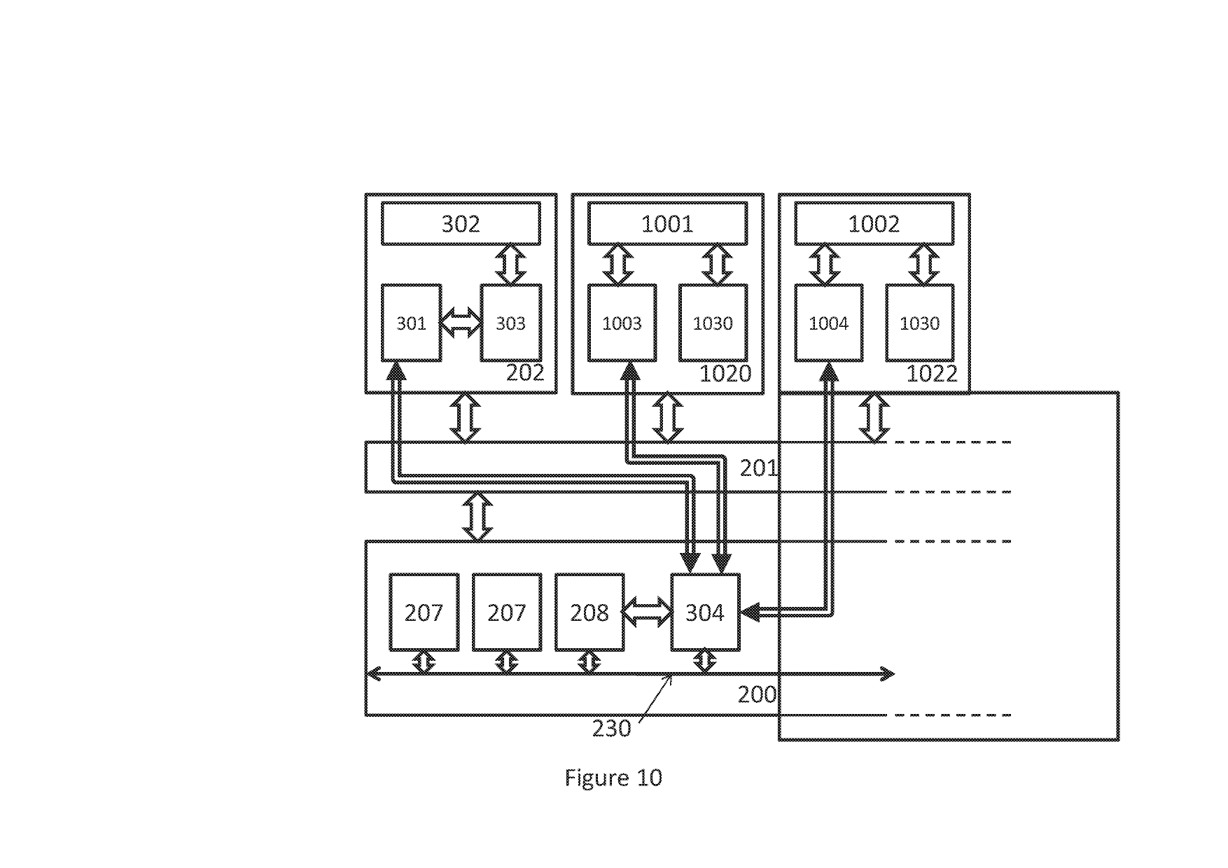

FIG. 10 is a functional block diagram of introspection FVMs 1020, 1022 according to an example. FVMs 1020 and 1022 include requesting applications 1001, 1002, each of which is arranged to determine the presence of different signatures, which signatures can be associated with the same or different threats. Accordingly, the memory locations 1003, 1004 mapped into each FVM 1020, 1022 relate to different parts of physical memory 208.

FVMs 1020, 1022 include a common page table 1030 which maps (not shown) to a physical memory address of memory 208. The shared memory is used to store data for FVMs 1020, 1022 which enables them to effectively ‘see’ and ‘know’ what other FVMs are doing and what is going on around them in a virtualized environment. Typically, the shared memory space is in the form of an information repository which can include information for each FVM (wherein each FVM can be provided with an identifier which makes it identifiable to other FVMs) which indicates, amongst other things, the VM that the FVM is currently scanning, the previous and/or next VM that the FVM is tasked to scan, and information indicating if any threats, signatures and/or behaviors which are suspicious have been detected. Accordingly, in response to a detected behavior or signature etc, other FVMs can alter their current task to ‘help’ the FVM which has detected something suspicious.

More specifically, in the example of FIG. 10, FVMs 1020, 1022 have access to a shared portion of physical memory which has been allocated by VMM 201. According to an example, the shared memory portion can include a task list for the FVMs. The FVMs 1020, 1022 access the shared memory using a page table 1030 in a similar way to that described above with reference to other examples. On a periodic basis, or in response to an indication from another FVM (such as a signal spread to other FVMs via VMM 201) FVMs 1020, 1022 can look up the shared data in the shared memory location in order to determine the current, past and/or future scanning tasks of FVMs instantiated on VMM 201. Accordingly for example, if FVM 1020 detects a signature S1 indicative of a threat T1, it can write data to the shared memory location indicating this fact (such as the signature detected (S1), the corresponding threat (T1), the VM in which S1 was detected (e.g. a location or other suitable identifier such as an address), a risk factor associated with either or both of S1 and T1, the owner of the potentially infected VM and so on). If the threat T1 is a higher risk threat, FVM 1020 can cause (via application 1001 for example) VMM 201 to effectively page other FVMs such as FVM 1022 in order to either cause them to inspect the shared memory location to determine the location of the infected VM (the VM in which S1 was detected), or to simply drop or finish their current task and scan the infected VM. The same can apply if the owner of the VM which is potentially affected is a high priority (“VIP”) owner. Alternatively, FVMs can determine the location of the potentially affected VM and redeploy to that VM as and when they determine the issue by inspection of the shared memory.

The example of FIG. 10 is generally analogous to a biological scenario for example in which FVMs communicate with one another for the purposes of ensuring that threats are managed in a timely, effective and decisive way. Accordingly, if a threat, signature or suspicious behavior is detected, FVMs will be aware of this and can modify their behavior in order to mitigate the expected risk associated with the potential threat. A notional police force of FVMs can therefore be present in a system, with FVMs cooperating with one another to determine the presence of threats. In such a scenario, a supervisory FVM can still be present, and may replace the shared memory location so that information is shared between FVMs via the supervisory FVM for example, as described above.

According to an example, a privileged (Dom0) VM typically includes device drivers etc which enable the use of physical resources for any VMs/FVMs. Accordingly, an extra layer of security can be implemented in the form of a network monitor in which network activity (and other activity such as disk and memory access activity) is monitored by the Dom0 VM. For example, as data packets pass through the Dom0 to the physical hardware, they can be inspected to determine whether they are legitimate or malicious. This forms an instantaneous form of protection which can be used to augment data from FVMs, and even to monitor FVMs themselves to ensure that they are performing within specification. As an example, if a threat tries to set up a TCP connection with an IP address which is outside of the range known to be permitted (such as a range of IP addresses in a company network, such as those in the form 16.xx.xxx.x for example), this may constitute suspicious behavior which can be used in isolation or in combination with data from FVMs. Alternatively, a hardware network monitor can be used, such a monitor interposing on activity before it reaches the physical hardware.

According to an example, an FVM is a lightweight virtual appliance, which can be, for example, a pared down typical VM. Being lightweight ensures that an FVM can easily be inspected—for example, if an FVM includes several million lines of machine-readable code or instructions, it will be difficult to maintain confidence that the FVM does not include anything which could cause it to be untrustworthy. Accordingly, by minimizing the size and complexity of FVMs, it is practicable to inspect them, perhaps on a periodic basis for example, to ensure that they are doing the job that they were tasked with doing. This can increase human confidence in the role of FVMs, and ensure that there is no easy place for malware or malicious code/instructions to ‘hide’ within an FVM.

What is claimed is:

1. A computerized method for detecting a threat by observing multiple behaviors of a computer system in program execution from outside of a host virtual machine, including:
mapping a portion of physical memory of the system to a forensic virtual machine to determine the presence of a first signature of the threat; and, on the basis of the determination deploying multiple further forensic virtual machines to determine the presence of multiple other signatures of the threat.

2. A method as claimed in claim 1, further comprising:
using a portion of shared physical memory to maintain an information repository for information sharing between forensic virtual machines.

3. A method as claimed in claim 1, further comprising:
using the multiple further forensic machines to scan multiple memory addresses allocated to the host virtual machine to determine the presence of a second signature indicative of the presence of the threat.

4. A method as claimed in claim 2, wherein forensic virtual machines periodically poll the portion of shared physical memory to determine a status of the computer system.

5. A method as claimed in claim 4, further comprising:
using the determined status to resolve a number of multiple further forensic virtual machines to deploy.

6. A device for secure computing, comprising:
a computer system, where the computer system includes a processor and a memory;
a virtual machine monitor program loaded onto the processor of the computer system to support a user-definable number of virtual machines;
a forensic virtual machine to read memory allocated by the virtual machine monitor to a virtual machine supported by the virtual machine monitor and to determine the presence of a signature indicative of a threat in the virtual machine, and;
a supervisory virtual machine to deploy multiple other forensic virtual machines to read memory allocated to the virtual machine to determine the presence of further signatures indicative of the threat.

7. A device as claimed in claim 6, wherein the supervisory virtual machine is operable to maintain a task list for forensic virtual machines, including a prioritized listing of virtual machines of the computer system.

8. A device as claimed in claim 6, wherein in deploying multiple other forensic virtual machines, the supervisory virtual machine is operable to determine a risk level associated with a threat.

9. A computer-readable medium storing computer-readable program instructions arranged to be executed on a computer, the instructions comprising:
to instantiate a virtual machine on the computer;
to maintain a task list for allocating a forensic virtual machine to examine a memory or disk location allocated to the virtual machine;
to use the task list to determine an allocation of multiple other forensic virtual machines to examine a memory or disk location allocated to the virtual machine to determine the presence of multiple signatures associated with a threat; and
to update the task list accordingly.

10. A device for secure computing, comprising:
a computer system, where the computer system includes a processor and a memory;
a virtual machine monitor program loaded onto the processor of the computer system to support a user-definable number of virtual machines;
a forensic virtual machine to read memory allocated by the virtual machine monitor to a virtual machine to determine the presence of a signature indicative of a threat in the virtual machine, and;
a shared memory location for storing data for the forensic virtual machine, wherein the shared memory location is accessible by other forensic virtual machines supported by the virtual machine monitor.

11. A device as claimed in claim 10, wherein the shared memory location is used to enable a forensic virtual machine to determine the presence of a potential threat in the virtual machine and to modify its behavior in response to the determined presence of the potential threat.

12. A method for detecting a threat in a virtualized system by using multiple autonomous, co-operative virtual appliances, the method comprising:
scanning a portion of memory allocated by a virtual machine monitor to a virtual machine in the system using a virtual appliance;
determining the presence of a behavior indicative of the threat in the virtual machine; and
on the basis of the determination, causing multiple further scans of the virtual machine using multiple other virtual appliances.
